(19) United States
(12) Patent Application Publication
(10) Pub. No.: US 2009/0089170 A1
(43) Pub. Date: Apr. 2, 2009

(54) METHOD FOR PROMOTING AN INCONTINENCE PRODUCT

(76) Inventors: Marisa Agresti, Milan (IT); Laura Armati, Milan (IT)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/239,085

(22) Filed: Sep. 26, 2008

Related U.S. Application Data
(60) Provisional application No. 60/975,931, filed on Sep. 28, 2007.

(51) Int. Cl. G06Q 30/00

(52) U.S. Cl. 705/14

(57) ABSTRACT

A method for promoting an incontinence product, the steps of which can include presenting to a person an unfavorable image associated with incontinence, presenting to the person a favorable image associated with being able to manage incontinence, the unfavorable image and the favorable image having at least one common feature, and presenting to the person an incontinence product for managing incontinence.

### CROSS-REFERENCE TO RELATED APPLICATION

This application claims the benefit of U.S. Provisional Application No. 60/975,931 filed on Sep. 28, 2007.

### FIELD OF THE INVENTION

The present invention relates to a method for promoting an incontinence product.

### BACKGROUND OF THE INVENTION

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

As the median age of populations has increased in many geographies over the last few decades, many women are facing the challenges of dealing with adult urinary incontinence. One cause of female adult urinary incontinence is the stress put on a woman's body during child bearing and birth. Child bearing and birthing can result in a weakening of the musculature surrounding the woman's urethra that allows for control of urination. Unfortunately, studies suggest that more than 50% of women occasionally experience urinary incontinence.

Urinary incontinence can have major detrimental impacts on the quality of life for women. Ordinary life activities such as laughing, coughing, sneezing, exercising, and playing actively with children can put stress on a woman's bladder such that the musculature surrounding the woman's urethra is unable to resist flow from the bladder, thereby resulting in a leak of urine. Depending on the color and texture of the clothing worn by a woman, a leak of urine can become an embarrassing public event. Even if other people around the woman do not see that the woman is suffering from urinary incontinence, the woman dealing with incontinence is often worried that others around her may notice the odor associated with urinary incontinence or see that she has leaked urine. Even if a urinary incontinent woman is able to successfully hide her condition from others, she still may feel uncomfortable with herself as she feels wetness in her undergarments.

The cumulative effects of living day after day with urine leakage and fear of leaks can make a woman feel older than she really is. In general, a woman dealing with urinary incontinence can feel a loss confidence in her ability to live her life free from the worry of when or where a leak might occur. Rather than taking on roles in which they can stand out, such as being an active part of large happy gathering of laughing people, wearing attractive clothing, standing in front of an audience and delivering a presentation, and taking part in physical activities, many women dealing with urinary incontinence choose to remain the background to avoid the potential for a leak of urine to cause an embarrassing situation.

There are a variety of products in the market to help a woman manage her incontinence. Indiscrete bulky diaper-like undergarments, absorbent pads, and the like are presented to women in a method that essentially emphasizes to the woman that she is no longer a young vibrant woman, that she has a problem, and that a technical solution for dealing with the physical consequences of the problem are what she needs. This approach may not address the psychological benefits that can be obtained by using a discrete and highly functional product for managing urinary incontinence. Psychological benefits such as confidence and the desire to stand out, rather than blend in, can also be accrued by a woman who uses a discrete and highly functional product for managing urinary incontinence.

Success of businesses marketing products to consumers can be very dependent on consumers understanding the benefits that can be delivered by a product being offered. One measure indicative of consumers' beliefs is purchase intent. Methods for creating high purchase intent are desirable because a consumer's intent to purchase an article is what can ultimately result in generating a sale. Generating purchase intent of female incontinence products can be challenging because of the psychological impacts that female incontinence has on women. There may be a fine line dividing methods that are repulsive and methods that are attractive to women dealing with incontinence.

With these limitations in mind, there is a continuing unaddressed need for methods for promoting female incontinence products.

### SUMMARY OF THE INVENTION

In one embodiment, the method of promoting an incontinence product comprises the steps of presenting to a person an unfavorable image associated with incontinence, presenting to the person a favorable image associated with being able to manage incontinence, the unfavorable image and the favorable image having at least one common feature, and presenting to the person an incontinence product for managing incontinence. The promotion of the incontinence product can be done via video media, print media, or any other media capable of conveying information to consumers.

In another embodiment, the method for promoting an incontinence product comprises the steps of presenting to a person a first image of a clothed woman wearing clothing having a clothing pattern, presenting to a person a second image that is at least a partial silhouette of the first image, presenting to the person a background pattern at least partially surrounding the first image and the second image, wherein the background pattern is substantially the same as the clothing pattern, and presenting to the person an incontinence product for managing incontinence.

### BRIEF DESCRIPTION OF THE DRAWINGS

FIG. 1 is a schematic of an unfavorable image thought to be associated with incontinence.

FIG. 2 is a schematic of a favorable image thought to be associated with incontinence.

FIG. 3 is a flow chart illustrative of an embodiment of the method for promoting an incontinence product.

FIG. 4 is a schematic of an embodiment that includes using a silhouette to invoke the benefits to be gained by using an incontinence product.

FIG. 5 is a gray-scale image of a color image that was shown to panelists.

FIG. 6 is a gray-scale image of a color still-shot from a video shown to panelists, the image illustrative of an unfavorable image thought to be associated with incontinence.

FIG. 7 is a gray-scale image of a color still-shot from a video shown to panelists, the image illustrative of a favorable image thought to be associated with being able to manage incontinence.

FIG. 8 is a gray-scale image of a color still-shot from a video shown to panelists, the image illustrative of an absorbent pad for managing incontinence.

### DETAILED DESCRIPTION OF THE INVENTION

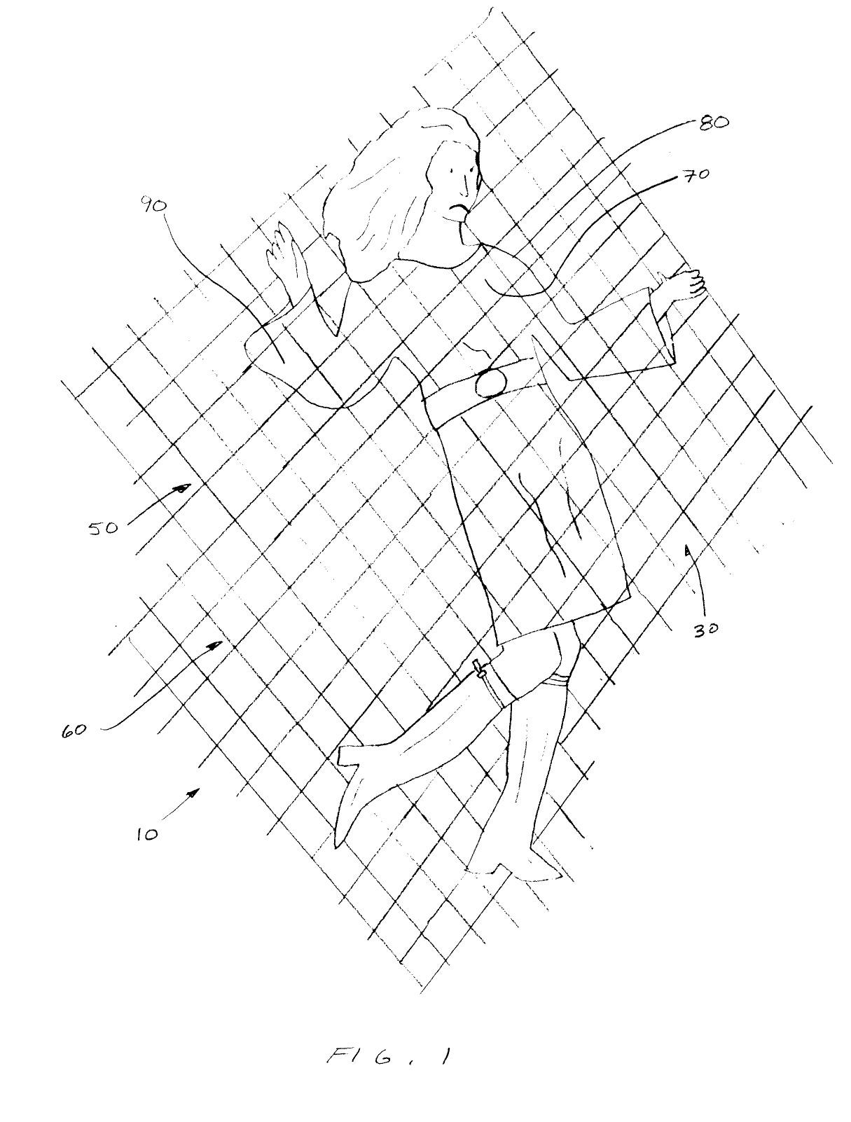

An incontinence product may be promoted by the following steps. An unfavorable image 10, as shown in FIG. 1, associated with incontinence is presented to a person. As shown in FIG. 1, the unfavorable image 10 can comprise a background 50 having a background pattern 60 and a foreground 70. As shown in FIG. 1, the foreground 70 can be that of a woman 80 wearing clothing 90 having a pattern that is substantially the same as the background pattern 60. By substantially the same, it is meant the that the patterns are the same except as they visually appear different due factors such as how the pattern would vary as a result of the pattern appearing on clothing 90 that drapes on the woman 80, i.e. folds, wrinkles, bends, and conforms to the woman 80 and the physical relationship between the position of the woman 80 and the background 50.

A background pattern 60 can be a solid color. For instance, the background pattern 60 can be solid red. In an unfavorable image 10, the woman 80 can be wearing clothing 90 that is solid red, like the background pattern 60. The background pattern 60 can also be a multicolor pattern. By color, the entire color spectrum is understood to be encompassed. That is, white and black are colors. One feature of the unfavorable image 10 can be that the woman 80 essentially blends in or is camouflaged against the background pattern 60. Another feature of the unfavorable image can be that the woman 80 is frowning or has a neutral facial expression.

Without being bound by theory, it is thought that persons challenged with incontinence viewing the unfavorable image 10 tend to identify with the unfavorable aspects of the unfavorable image 10. For instance, if the background pattern 60 is solid blue and the woman 80 in the unfavorable image 10 is wearing clothing 90 that is also solid blue that blends in with the background pattern 60, the person viewing the unfavorable image 10 may identify the woman 80 in the unfavorable image 10 as blending in or trying to stay in the background because the woman 80 is dealing with incontinence. For women who suffer from urinary incontinence, there may be many of whom identify with the woman 80 portrayed in the unfavorable image 10. That is, the viewer may recognize that she tends to try to hide her incontinence problem and avoid situations in which her incontinence problem may become known to others. In FIG. 1, unfavorable aspects of the image include that the woman 80 is not smiling.

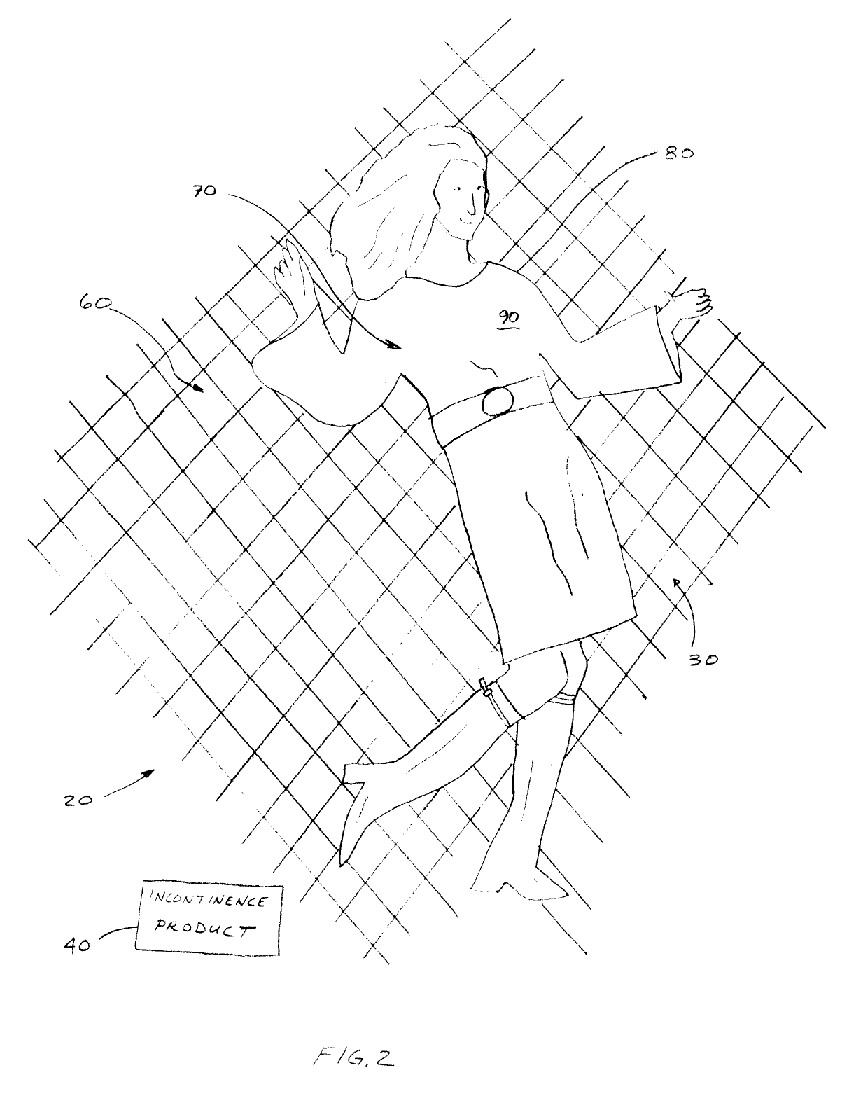

A favorable image 20, as shown in FIG. 2, associated with being able to manage incontinence, the unfavorable image 10 and favorable image 20 having at least one common feature 30, can be presented to the person. Associated with the unfavorable image 10 and favorable image 20, an incontinence product 40 for managing incontinence can be presented to the person. As shown in FIG. 2, the favorable image 20 can comprise a background pattern 60 and a foreground 70, the foreground 70 being that of a woman 80 wearing clothing 90 having a pattern that substantially differs from the background pattern 60. The common feature can be the background pattern 60, the woman 80 appearing in each image, the clothing 90 worn by the woman 80, or some other common element. For instance, the clothing 90 can have the same pattern as the background pattern 60.

In a favorable image 20, the image can comprise a background pattern 60 and a foreground 70, the foreground 70 being a woman 80 wearing clothing 90 that is a solid color that substantially differs from the background pattern 60. One feature of the favorable image 20 can be that the woman 80 stands out against the background pattern 60.

Without being bound by theory, it is believed that persons viewing the favorable image 20 may tend to identify with the favorable aspects of the favorable image 20. For instance, if the woman 80 in the favorable image 20 is wearing clothing 90 that has a pattern that differs from the background pattern 60, the person viewing the favorable image 20 may identify the woman 80 in the favorable image 20 as standing out, confident, and/or in control. It is thought that women suffering from urinary incontinence may associate this type of favorable image 20 as a desired emotional state. This association by the viewer who has one emotional state that is represented by the unfavorable image 10 when she views the favorable image 20, which may conjure up the desire of achieving an improved emotional state of confidence and wanting to stand out, may generate a powerful intent to purchase the incontinence product 40 as compared to the intent to purchase that is typically measured by industry for typical consumer products. In FIG. 2, one favorable aspect of the image can be that the woman 80 is smiling.

The incontinence product 40 can be an absorbent article designed to be worn in the crotch region of a woman. For instance, the incontinence product can comprise a topsheet, a backsheet, an absorbent core, and an odor control material, as is known in the art.

The incontinence product 40 can be a vaginal pessary designed to support or apply pressure to the urethra and/or provide support for the bladder exit.

The incontinence product 40 can be a pharmaceutical is a medicinally appropriate amount for treating female urinary incontinence.

The incontinence product 40 can be selected from the group consisting of an absorbent article, a pessary, and a pharmaceutical.

In one embodiment of the invention, a method for promoting an incontinence product can comprise the step of prompting the person being addressed to conduct a self assessment to determine if the person can benefit from the incontinence product for managing incontinence. The prompting can be a direct or implicit message such as directing the person being addressed to ask herself if she believes the unfavorable image 10 is representative of her emotional state.

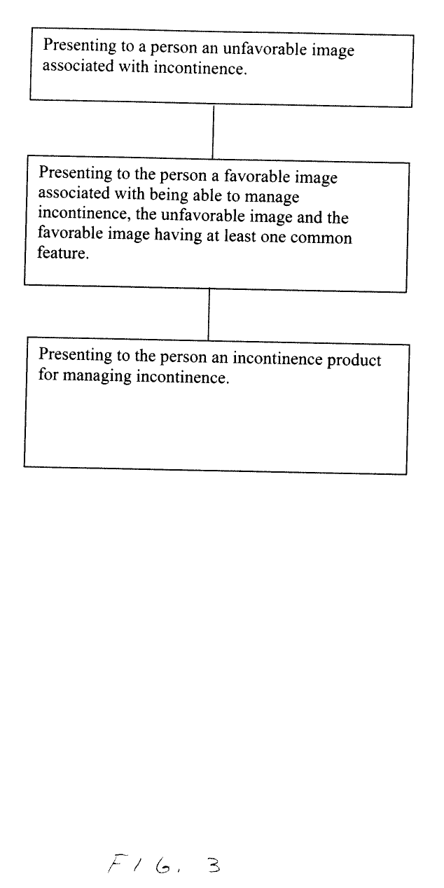

A flow chart illustrative of one embodiment of the method for promoting an incontinence product is illustrated in FIG. 3.

In another embodiment of the invention, an incontinence product can be promoted using a method that includes using a silhouette to invoke the benefits to be gained by using an incontinence product. FIG. 4 illustrates a first image 100 of a clothed woman 80 wearing clothing 90 having a clothing pattern 110. As further illustrated in FIG. 4, a second image 120 can be presented to a person, the second image 120 being at least a partial silhouette of the first image 100. A person can be presented a background pattern 60 that at least partially surrounds the first image 100 and the second image 120. The background pattern 60 can be substantially the same as the clothing pattern 110. As part of the method for promoting an incontinence product, an incontinence product 40 for managing incontinence can be presented to the person. The background pattern 60 can be different than the clothing pattern 110.

Without being bound by theory, it is thought that the silhouette or partial silhouette as second image 120 stimulates the viewing person to recognize the transformational change that might occur in her emotional state should she use the incontinence product 40. That is, the viewing person may understand that she can exude confidence and stand out among the crowd if she chooses to purchase and use the incontinence product 40. To the person viewing the first image 100, the silhouetting generates the appearance that the first image 100 of a clothed woman 80 is stepping out of the background. This transformation, or stepping out of the background, is a transformational metaphor for the person viewing the first image 100. That is, the viewer can recognize the transformation in her emotional state that might occur should she choose to purchase and use the incontinence product 40.

To assess the effectiveness of the method of promoting an incontinence product, two studies were initiated. In the first study, a panel of 153 women, 35 years old or older, who experience adult urinary incontinence was recruited. Panelists who use a urinary incontinence product were characterized as having either light urinary incontinence or heavy urinary incontinence depending on the type of product used. Panelists who had used thin products, such as panti-liners, which have little capacity to absorb urine but provide protection against small leaks, were classified as having light urinary incontinence. Panelists who had used thick products, which have the capacity to absorb a large amount of urine, were classified as having heavy urinary incontinence.

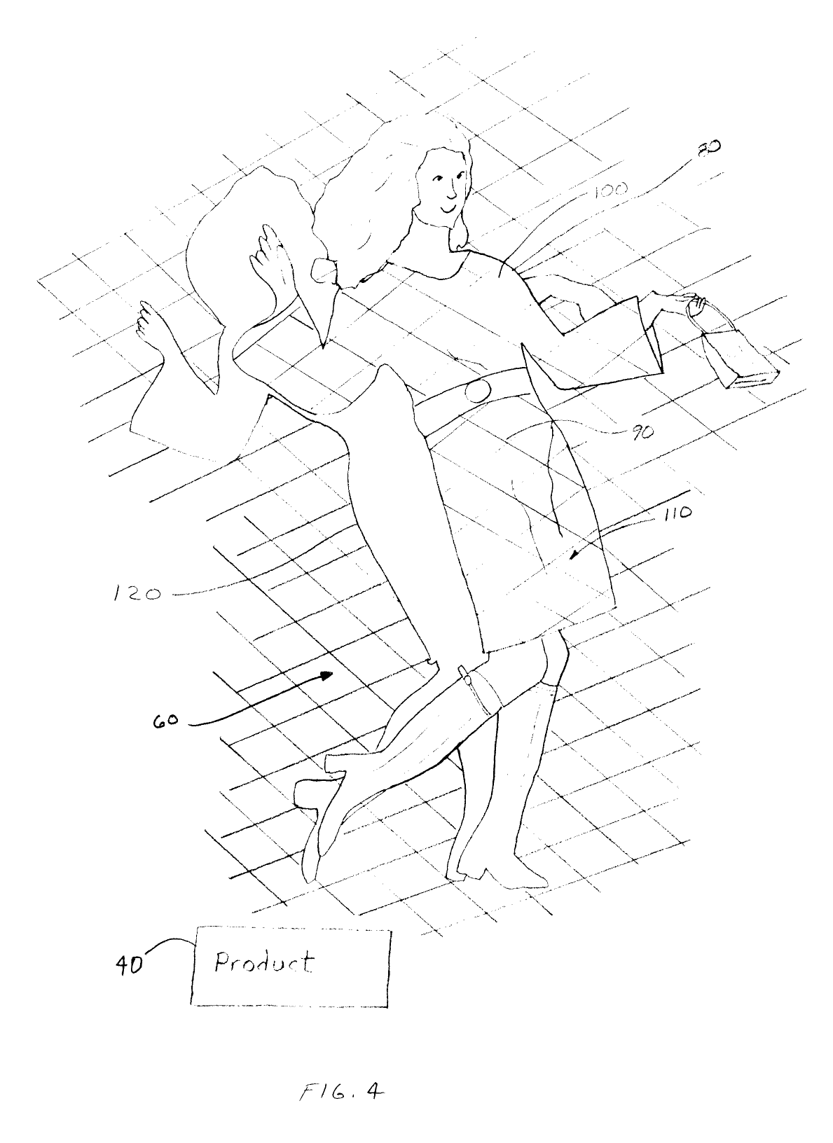

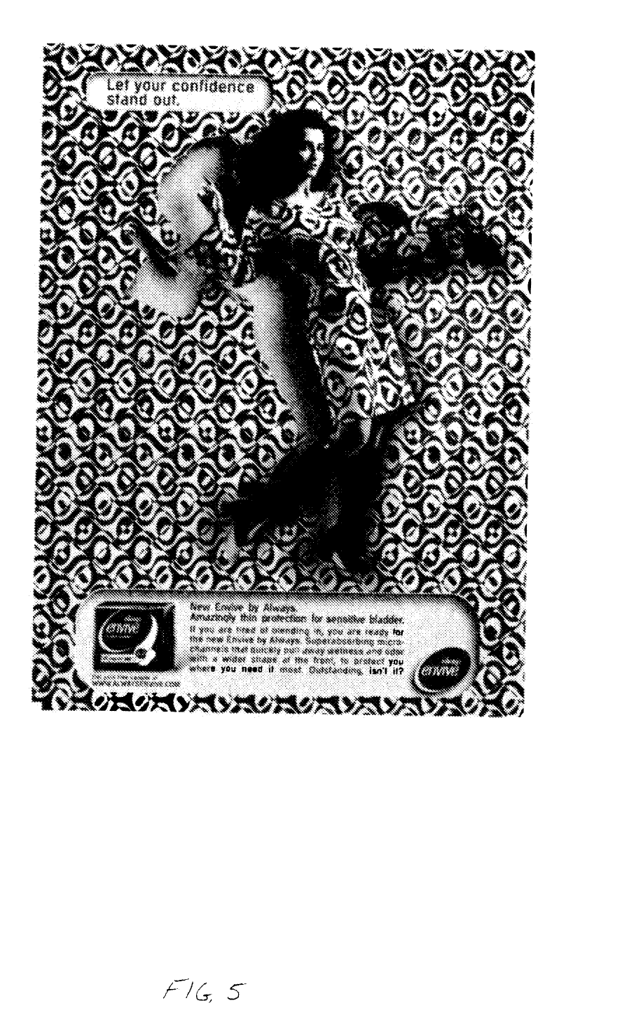

As a control question, panelists were asked “Which of the following best describes how likely you would be to buy any Always pads to deal with unintentional urine loss?” the choices being “Definitely would buy”, “Probably would buy”, “Might or might not buy”, “Probably would not buy”, “Definitely would not buy any Always Pads to deal with unintentional urine loss”. The purchase intent was measured as the sum of the percentage of panelists in the group answering “Definitely would buy” and “Probably would buy”. The panel was then shown a color version of the image in FIG. 5. After being shown a color version of the image in FIG. 5, each panelist was asked “Which of the following best describes how likely you would be to buy any Always pads to deal with unintentional urine loss?” the choices being “Definitely would buy”, “Probably would buy”, “Might or might not buy”, “Probably would not buy”, “Definitely would not buy any Always Pads to deal with unintentional urine loss”. ALWAYS pads are distributed by Procter & Gamble Co., Cincinnati, Ohio. The purchase intent, after the panelist was subjected to the method for increasing purchase intent, was measured. The measurable indicator of the effectiveness of the method for promoting an incontinence product for each group was the change in the purchase intent occurring after the panelists were shown a color version of the image in FIG. 5.

Without being bound by theory, the measure of purchase intent is thought to provide quantitative information regarding how well a promotional method works. Purchase intent can be analyzed based on the raw percentage measured, the change in purchase intent that may occur as a result of stimuli, and/or as the difference in purchase intent for a particular product against industry norms in the same category of products or similar categories of products.

As shown in Table 1, applying the method to panelists who experience urinary incontinence increased the purchase intent by 22%. Panelists who experience urinary incontinence can represent the strategic target consumer for products designed to manage urinary incontinence. A 22% increase in purchase intent is believed to be a striking positive effect. As listed in Table 1, subsets of the panel, based on the intensity of their urinary incontinence, whether or not they have used an incontinence product, and the type of products they use, respond differently to the method for increasing purchase intent.

TABLE 1
Print Approach with second image that is at least
a partial silhouette of the first image.

| | | | Change in |
|---|---|---|---|
| | | | Percentage |
| | | | of |
| | | | “Definitely/ |
| | Number | | Probably |
| | of | | Would |
| Viewing Population | Viewers | Product Discussed | Buy” |
| Women who experience | 153 | Any ALWAYS pad | +22% |
| urinary incontinence | | | |
| Women who experience | 131 | Any ALWAYS pad | +19% |
| urinary incontinence and | | | |
| use a product to manage | | | |
| urinary incontinence | | | |
| Women who currently use | 34 | Any ALWAYS pad | +35% |
| light urinary incontinence | | | |
| liners and pads | | | |
| Women who currently use | 21 | Any ALWAYS pad | +15% |
| moderate urinary | | | |
| incontinence pads | | | |
| Women who experience | 48 | Any ALWAYS pad | +9% |
| urinary incontinence and | | | |
| use feminine protection | | | |
| pads to manage | | | |
| incontinence | | | |

In the second study, the results of which are listed in Table 2, a panel of 107 women between the ages of 35 and 65 was recruited. The panel included women with and without incontinence. The panelists were shown an animatic, which is a series of still images. The animatic included an unfavorable image believed to be associated with incontinence. The image was of a woman wearing clothing that had a pattern that was substantially the same as the background pattern such that the woman blended in with the background. The panelists were subsequently presented with a favorable image believed to be associated with being able to manage incontinence in which there was a common feature between the unfavorable image and the favorable image. The panelists were also presented an incontinence product for managing incontinence.

After being shown the animatic, each panelist was asked “Which of the following best describes how likely you would be to buy Always Envive Pads or Liners?” the choices being “Definitely would buy”, “Probably would buy”, “Might or might not buy”, “Probably would not buy”, “Definitely would not buy Always Envive Pads or Liners to deal with unintentional urine loss”. The purchase intent was measured as the sum of the percentage of panelists in the group answering “Definitely would buy” and “Probably would buy”. To evaluate the effectiveness of the method for promoting an incontinence product, the purchase intent measured for the panelists who saw the animatic was compared to the average purchase intent for other methods employed by the Procter & Gamble Co. to increase sales of a product, the difference between the two believed to provide information about the effectiveness of the method. The comparison against data from the Procter & Gamble Co. is thought to provide valuable information because the Procter & Gamble Co. sells multiple billions of dollars worth of consumer goods throughout the world. The viewing population was analyzed in two groups. The first group was women who experience urinary incontinence. The second group was women who experience urinary incontinence and use absorbent pads to manage urinary incontinence. The first and second groups are not mutually exclusive.

As shown in Table 2, applying the method to panelists, depending on the group to which the panelists belonged, resulted in a difference in purchase intent versus Procter & Gamble Co. Average of −3% to 35%. For women who use absorbent pads to manage urinary incontinence, who can be a strategic target for manufacturers of incontinence products, the 35% difference in purchase intent versus the Procter & Gamble Co. average is believed to be striking. That is, the method of promoting an incontinence product appears to tend to result in a higher purchase intent for desired audiences than the Procter & Gamble Co. average. Although the purchase intent of the entire panel was lower than the Procter & Gamble Co. average, this value is not viewed as being critically important because the broader group of all women is not the target of the method. Rather, the method can be more suitable for women who experience urinary incontinence and/or women who are open to using absorbent pads to manage urinary incontinence because these women are the prospective consumers of products aimed at managing urinary incontinence.

TABLE 2
Animatic study showing an unfavorable image thought to be
associated with incontinence, a favorable image thought to be
associated with being able to manage incontinence,
and an incontinence product for managing incontinence.

| | | | Difference in |
|---|---|---|---|
| | | | Purchase Intent vs. |
| | Number of | Product | Procter & Gamble |
| Viewing Population | Viewers | Presented | Co. Average |
| Women (entire panel) | 107 | ALWAYS | −3% |
| | | ENVIVE | |
| Women who experience | 69 | ALWAYS | +8% |
| urinary incontinence | | ENVIVE | |
| Women who experience | 50 | ALWAYS | +35% |
| adult urinary | | ENVIVE | |
| incontinence and use | | | |
| absorbent pads to | | | |
| manage urinary | | | |
| incontinence | | | |

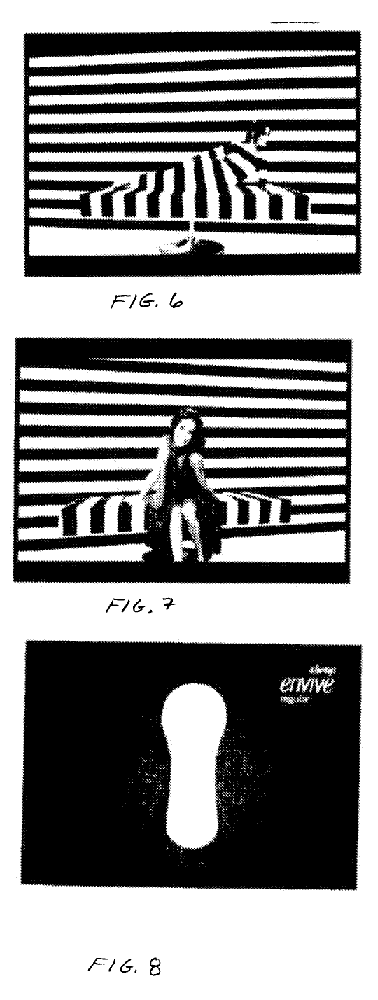

In a third study, the results of which are listed in Table 3, a panel of 121 women between the ages of 35 and 65 was recruited. The panelists were shown a thirty second video in which the women were presented motion video showing four unfavorable images believed to be associated with incontinence. The images were of women wearing clothing that had a pattern that was substantially the same as the background pattern such that the women blended in with the background. The panelists were subsequently presented with four favorable images believed to be associated with being able to manage incontinence in which there was a common feature between the unfavorable image and the corresponding favorable image. The panelists were also presented an incontinence product for managing incontinence. The video was accompanied by a narrative, as follows; “Are you ready to rediscover the pleasure of standing out? Discover the new Envive by Always. Specifically designed for sensitive bladder with super absorbing micro-channels to quickly pull away wetness and odor. Outstanding protection for confidence that stands out. New Envive by Always. Protects your daring instinct.” A product called ALWAYS ENVIVE was shown in the video. Examples of portions of the video copy, in grey scale, are shown in FIGS. 6, 7, and 8.

After being shown the video, each panelist was asked “Which of the following best describes how likely you would be to buy Always Envive incontinence products?” the choices being “Definitely would buy”, “Probably would buy”, “Might or might not buy”, “Probably would not buy”, “Definitely would not buy any Always Envive incontinence products”. The purchase intent was measured as the sum of the percentage of panelists in the group answering “Definitely would buy” and “Probably would buy”. To evaluate the effectiveness of promoting an incontinence product, the purchase intent measured for the panelist who watched the video was compared to the average purchase intent for other methods employed by the Procter & Gamble Co. to promote products, the difference between the two believed to provide information about the effectiveness of the method. The viewing population was analyzed in two groups. The first group being women who experience urinary incontinence and the second group being women who experience urinary incontinence and use absorbent pads to manage urinary incontinence, the groups not being mutually exclusive.

As shown in Table 3, applying the method to panelists, depending on the group to which the panelists belonged, resulted in a difference in purchase intent versus the Procter & Gamble Co. average by 12% to 24%. For women who use absorbent pads to manage urinary incontinence, who can be a strategic target for manufacturers of incontinence products, the 17% difference in purchase intent versus the Procter & Gamble Co. average is believed to be striking. The relative high difference in purchase intent versus the Procter & Gamble Co. average is believed to be indicative that the method of promoting an incontinence product performs well.

TABLE 3
Video approach showing unfavorable and favorable images
though to be associated with incontinence and an incontinence
product for managing incontinence.

| | | | Difference in |
|---|---|---|---|
| | | | Purchase Intent vs. |
| | Number of | Product | Procter & Gamble |
| Viewing Population | Viewers | Presented | Co. Average |
| Women who experience | 121 | ALWAYS | 12% |
| urinary incontinence | | ENVIVE | |
| Women who experience | 118 | ALWAYS | 16% |
| urinary incontinence and | | ENVIVE | |
| use a product to manage | | | |
| urinary incontinence | | | |
| Women who currently | 57 | ALWAYS | 24% |
| use light urinary | | ENVIVE | |
| incontinence liners and | | | |
| pads | | | |
| Women who currently | 56 | ALWAYS | 23% |
| use moderate urinary | | ENVIVE | |
| incontinence pads | | | |
| Women who experience | 52 | ALWAYS | 17% |
| urinary incontinence and | | ENVIVE | |
| use feminine protection | | | |
| pads to manage | | | |
| incontinence | | | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for promoting an incontinence product comprising the steps of:
a. presenting to a person an unfavorable image associated with incontinence;
b. presenting to said person a favorable image associated with being able to manage incontinence, said unfavorable image and said favorable image having at least one common feature; and
c. presenting to said person an incontinence product for managing incontinence.

2. The method according to claim 1, wherein said unfavorable image comprises a background having a background pattern and a foreground, said foreground being that of a woman wearing clothing having a pattern that is substantially the same as said background pattern.

3. The method according to claim 2, wherein said background pattern is a solid color.

4. The method according to claim 2, wherein said background pattern is a multi-color pattern.

5. The method according to claim 1, wherein said favorable image comprises a background pattern and a foreground, said foreground being that of a woman wearing clothing having a pattern that substantially differs from said background pattern.

6. The method according to claim 1, wherein said favorable image comprises a background pattern and a foreground, said foreground being that of a woman wearing clothing that is a solid color that substantially differs from said background pattern.

7. The method according to claim 1, wherein said incontinence product is selected from the group consisting of an absorbent article, a pessary, and a pharmaceutical.

8. The method according to claim 1, further comprising the step of prompting said person to conduct a self assessment to determine if said person can benefit from said incontinence product for managing incontinence.

9. The method according to claim 1, wherein purchase intent of said product is increased.

10. A method for promoting an incontinence product comprising the steps of:
a. presenting to a person an unfavorable image associated with incontinence, wherein said unfavorable image comprises a background having a background pattern;
b. presenting to said person a favorable image associated with being able to manage incontinence, wherein said favorable image comprises a background pattern and a foreground, said foreground being that of a woman wearing clothing having a pattern that substantially differs from said background pattern; and
c. presenting to said person an incontinence product for managing incontinence.

11. The method according to claim 10, wherein said background pattern is a solid color.

12. The method according to claim 10, wherein said background pattern is a multi-color pattern.

13. The method according to claim 10, wherein said favorable image comprises a background pattern and a foreground, said foreground being that of a woman wearing clothing that is a solid color that substantially differs from said background pattern.

14. The method according to claim 10, wherein said incontinence product is selected from the group consisting of an absorbent article, a pessary, and a pharmaceutical.

15. The method according to claim 10, further comprising the step of prompting said person to conduct a self assessment to determine if said person can benefit from said incontinence product for managing incontinence.

16. The method according to claim 10, wherein purchase intent of said product is increased.

17. A method for promoting an incontinence product comprising the steps of:
a. presenting to a person a first image of a clothed woman wearing clothing having a clothing pattern;
b. presenting to said person a second image that is at least a partial silhouette of said first image;
c. presenting to said person a background pattern at least partially surrounding said first image and said second image, wherein said background pattern is substantially the same as said clothing pattern; and
d. presenting to said person an incontinence product for managing incontinence.

18. The method according to claim 17, wherein said background pattern is a solid color.

19. The method according to claim 17, wherein said background pattern is a multi-color pattern.

20. The method according to claim 17, wherein said incontinence product is selected from the group consisting of an absorbent article, a pessary, and a pharmaceutical.

21. The method according to claim 17, wherein purchase intent of said product is increased.
